(19) United States
(12) Patent Application Publication
(10) Pub. No.: US 2026/0175933 A1
(43) Pub. Date: Jun. 25, 2026

(54) SADDLE STRUCTURE AND BICYCLE

(71) Applicant: Hongwei WANG, Sanya (CN)

(72) Inventor: Hongwei WANG, Sanya (CN)

(21) Appl. No.: 18/725,383

(22) PCT Filed: Jun. 5, 2024
(86) PCT No.: PCT/CN2024/097489

§ 371 Date: Jun. 28, 2024

(30) Foreign Application Priority Data
Apr. 30, 2024 (CN) 202420936847.X

(51) Int. Cl. B62J 1/08

(52) U.S. Cl. CPC B62J 1/08

(57) ABSTRACT

The present application discloses a saddle structure and a bicycle. The saddle structure includes a seat member. The seat member is configured to be horizontally arranged along a transverse direction at a top of a seat tube of the bicycle. A cross-section of the seat member perpendicular to the transverse direction includes an arc portion extending for at least three fourths of a full circle. The arc portion is disposed at a top part of the cross-section. Through the present application, when a rider rides the bicycle equipped with the saddle structure with a forward-leaning posture, the perineal region of the rider can be kept from being pressed and injured, blood circulation in legs can be promoted, riding fatigue can be mitigated, and the safety factor of steering during riding can be improved.

### CROSS-REFERENCE TO RELATED APPLICATION

This application claims priority to Chinese Patent Application No. 202420936847.X, entitled “SADDLE STRUCTURE AND BICYCLE”, filed with the China National Intellectual Property Administration on Apr. 30, 2024, the disclosure of which is hereby incorporated by reference in its entirety.

### TECHNICAL FIELD

The present application relates to the field of bicycle technologies, and specifically to a saddle structure and a bicycle.

### BACKGROUND

With the continuous development of society, bicycles have developed from conventional bicycles into current bicycle models such as road bicycles, mountain bicycles, and the like. Riding postures also have evolved from riding with the upper body straight into riding mainly with the upper body leaning forward. Corresponding bicycle saddles also have gradually evolved from conventional bicycle saddles into the following two structures: One is a narrow and elongated strip-shaped bicycle saddle (referred to as a strip-shaped saddle below, as shown in FIG. 1). The strip-shaped saddle is relatively commonly used. The strip-shaped saddle overcomes the problem that a conventional bicycle saddle rubs the inner sides of the thighs during riding. However, the strip-shaped saddle tends to press the perineal region of a rider during riding to cause injury. Due to the physiological structure characteristics of the perineal region being sensitive and vulnerable, such injury cannot be changed through exercise and adaptation. Such injury persists as long as riding takes place, and eventually becomes unrecoverable. The other is a bicycle saddle obtained by removing the front end of a conventional bicycle saddle and keeping the rear half (referred to as a noseless saddle below, as shown in FIG. 2). The noseless saddle supports the buttocks of a rider with a planar shape during riding. The noseless saddle overcomes the problem that the strip-shaped saddle presses and injures the perineal region of a rider during riding. However, the noseless saddle also has unsafe factors. For example, the noseless saddle rubs the roots of the thighs of a rider during riding, the buttocks of the rider tend to slip off the saddle, and the saddle is not conducive to manipulation and as a result the bicycle tends to fall during steering. Therefore, there is currently an urgent need for a bicycle saddle that can avoid pressing and injuring the perineal region of a rider when the rider rides with a forward-leaning posture and also can avoid a likely fall at steering during riding.

### SUMMARY OF THE INVENTION

Therefore, a technical problem to be resolved by the present application is to overcome the deficiencies in the prior art that a saddle applied to a bicycle cannot avoid pressing and injuring the perineal region of a rider when the rider rides with a forward-leaning posture and also cannot avoid a likely fall at steering during riding, and provide a saddle structure and a bicycle.

A saddle structure provided according to a first aspect of the present application is applied to a bicycle. The saddle structure includes:
a seat member, configured to be horizontally arranged at along a transverse direction a top of a seat tube of the bicycle, where a cross-section of the seat member perpendicular to the transverse direction includes an arc portion extending for at least three fourths of a full circle, and the arc portion is disposed at a top part of the cross-section.

The saddle structure according to the present application at least has the following technical effects:
1. The seat member is arranged at the top of the seat tube of the bicycle in the transverse direction, and the cross-section of the seat member includes the arc portion that is disposed at the top part of the cross-section and extends for at least three fourths of the full circle. When a rider rides the bicycle equipped with the saddle structure with a forward-leaning posture, a special arc-shaped support surface of the seat member is configured to support the buttocks and the rear sides of the thighs of the rider, so that a support point of the seat member for the body of the rider can smoothly change from the ischial tuberosity to the rear-side region of the thighs of the rider, and the support point of the seat member for the body of the rider changes synchronously and consistently with a riding posture. In one aspect, the center of gravity of the human body of the rider and the center of gravity of the bicycle change harmoniously and consistently during movement, allowing the riding to cope with complex and varied road conditions more stably, thereby ensuring riding safety. In another aspect, muscles at different positions from the ischial tuberosity to the rear-side region of the thighs alternately bear pressing and rest to achieve comfort and health protection, and the perineal region of the rider is not pressed. When the rider rides the bicycle equipped with the saddle structure with a forward-leaning posture, the perineal region of the rider can be kept from being pressed and injured, and it can be ensured that the bicycle does not fall easily at steering during riding.
2. The seat member is connected to the seat tube of the bicycle. When the rider steers the bicycle equipped with the saddle structure during riding, with the seat tube as an axis, one side of the body of the rider presses an end on the same side of the seat member through the support point to generate a steering force, so that the overall bicycle equipped with the saddle structure naturally steers, thereby overcoming the problem of inharmonious overall steering of a bicycle with a noseless saddle in the prior art, improving the safety factor of riding, and more effectively avoiding a likely fall when the rider steers the bicycle equipped with the saddle structure during riding.

Optionally, the cross-section of the seat member perpendicular to the transverse direction is arranged to be circular.

Optionally, the seat member is arranged to have a hollow portion.

Optionally, a flexible cushion is disposed on a peripheral surface of the seat member.

Optionally, the flexible cushion is provided with an avoidance groove at a position corresponding to a bottom part of the seat member, and the bottom part of the seat member is formed with a first through-hole penetrating in a vertical direction; and the first through-hole is in communication with an inner cavity of the seat member.

Optionally, at least one end of the seat member in the transverse direction is formed with a second through-hole penetrating in the transverse direction, and the second through-hole is in communication with an inner cavity of the seat member.

Optionally, each of two ends of the seat member in the transverse direction is formed with the second through-hole penetrating in the transverse direction.

Optionally, the flexible cushion is arranged to be a skin layer;
and/or, a mounting cavity is defined between an inner side wall of the flexible cushion and the peripheral surface of the seat member, and a flexible filler is disposed in the mounting cavity. Optionally, an outer wall of the flexible cushion is provided with an anti-slip annular band at each of two ends thereof in the transverse direction, and the anti-slip annular band is arranged along a circumferential direction of the seat member.

A bicycle provided according to a second aspect of the present application includes a seat tube and a saddle structure disposed at a top of the seat tube, where the saddle structure is configured as the saddle structure provided in the foregoing first aspect.

The bicycle according to the present application at least has the following technical effects:
1. In the saddle structure, the seat member is arranged at the top of the seat tube in the transverse direction, and the cross-section of the seat member includes the arc portion that is disposed at the top part of the cross-section and extends for at least three fourths of the full circle. When a rider rides the bicycle with a forward-leaning posture, a special arc-shaped support surface of the seat member is configured to support the buttocks and the rear sides of the thighs of the rider, so that a support point of the seat member for the body of the rider can smoothly change from the ischial tuberosity to the rear-side region of the thighs of the rider, and the support point of the seat member for the body of the rider changes synchronously and consistently with a riding posture. In one aspect, the center of gravity of the human body of the rider and the center of gravity of the bicycle change harmoniously and consistently during movement, allowing the riding to cope with complex and varied road conditions more stably, thereby ensuring riding safety. In another aspect, muscles at different positions from the ischial tuberosity to the rear-side region of the thighs alternately bear pressing and rest to achieve comfort and health protection, and the perineal region of the rider is not pressed. When the rider rides the bicycle with a forward-leaning posture, the perineal region of the rider can be kept from being pressed and injured, and it can be ensured that the bicycle does not fall easily at steering during riding.
2. In the saddle structure, the seat member is connected to the seat tube. When the rider steers the bicycle during riding, with the seat tube as an axis, one side of the body of the rider presses an end on the same side of the seat member through the support point to generate a steering force, so that the overall bicycle naturally steers, thereby overcoming the problem of inharmonious overall steering of a bicycle equipped with a noseless saddle in the prior art, improving the safety factor of riding, and more effectively avoiding a likely fall when the rider steers the bicycle during riding.

The additional aspects and advantages of the present application are partially provided in the following description and partially become obvious from the following description or understood through the practice of the present application.

### BRIEF DESCRIPTION OF THE DRAWINGS

To describe the technical solutions in specific embodiments of the present application or the prior art more clearly, the following briefly introduces the accompanying drawings required for describing the specific embodiments or the prior art. Apparently, the accompanying drawings in the following description show some embodiments of the present application, and a person of ordinary skill in the art may still derive other drawings from these accompanying drawings without creative efforts.

FIG. 1 is a three-dimensional schematic structural diagram of a strip-shaped saddle in the prior art;

FIG. 2 is a schematic structural top view of a noseless saddle in the prior art;

FIG. 3 is a schematic structural exploded view of assembling a saddle structure and a seat tube according to a first embodiment;

FIG. 4 is a three-dimensional schematic structural diagram of assembling a saddle structure and a seat tube according to a first embodiment;

FIG. 5 is a three-dimensional schematic structural diagram of assembling a saddle structure and a seat tube according to a second embodiment;

FIG. 6 is a schematic structural side view of a seat member of a saddle structure according to a third embodiment; and FIG. 7 is a schematic structural diagram of a bicycle equipped with a saddle structure in this embodiment.

### REFERENCE NUMERALS

1—seat member, 11—first through-hole, 12—second through-hole, 13—arc portion, and 14—horizontal portion;
2—seat tube;
3—flexible cushion, 31—avoidance groove, and 32—anti-slip annular band; and
4—vertical tube.

### DETAILED DESCRIPTION

The following clearly and completely describes the technical solutions in the present application with reference to the accompanying drawings. Apparently, the embodiments described below are some embodiments of the present application rather than all the embodiments. All other embodiments obtained by a person of ordinary skill in the art based on embodiments of the present application without creative efforts shall fall within the protection scope of the present application. In the description of the present application, it needs to be noted that orientation or location relationships indicated by terms “center”, “up”, “down”, “left”, “right”, “vertical”, “horizontal”, “inside”, and “outside” are based on orientation or location relationships shown in the accompanying drawings, and are only used to facilitate description of the present application and simplify description, but are not used to indicate or imply that the apparatuses or elements must have specific orientations or are constructed and operated by using specific orientations, and therefore, cannot be understood as a limitation to the present application. In addition,, the terms “first”, “second”, and “third” are used only for description, but are not intended to indicate or imply relative importance.

In the description of the present application, it needs to be noted that unless otherwise expressly specified and defined, “mounted”, “connected”, and “connection” should be understood in a broad sense, for example, fixedly connected, detachably connected, or integrally connected; or mechanically connected, or electrically connected; or connected directly or through an intermediate, or two elements communicated internally. A person of ordinary skill in the art may understand specific meanings of the foregoing terms in the present application according to specific cases.

In addition, the technical features involved in different embodiments of the present application described below can be combined with each other as long as they do not constitute a conflict between them.

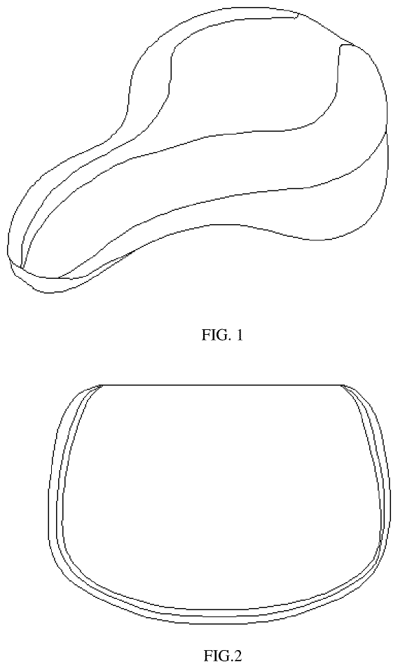

At present, saddles applied to bicycles mainly include the following two structures: One is a narrow and elongated strip-shaped saddle (as shown in FIG. 1). The strip-shaped saddle overcomes the problem that a conventional bicycle saddle rubs the inner sides of the thighs during riding. However, the strip-shaped saddle tends to press the perineal region of a rider during riding to cause injury. The other is a noseless saddle obtained by removing the front end of a conventional bicycle saddle and keeping the rear half (as shown in FIG. 2). The noseless saddle supports the buttocks of a rider with a planar shape during riding. The noseless saddle overcomes the problem that the strip-shaped saddle presses and injures the perineal region of a rider during riding. However, there are also has unsafe factors. For example, the noseless saddle rubs the roots of the thighs of a rider during riding, the buttocks of the rider tend to slip off the saddle, and the saddle is not conducive to manipulation and as a result the bicycle tends to fall during steering. For the noseless saddle, when the handlebar of the bicycle drives the front wheel to integrally steer, because the noseless saddle lacks a front end of a conventional saddle or a strip-shaped saddle, the inner sides of the thighs of a rider can no longer hold the front end of the saddle and use a lever with a seat tube of the saddle as a fulcrum to apply a steering force to steer. Without the action of the force of the lever, the rider can only twist the waist and hip to apply a limited steering force to the rear-end portion of the bicycle through a saddle surface of the bicycle saddle. As a result, the rear end of the bicycle and the rider cannot synchronously achieve the objective of synchronously steering along with the front end of the bicycle, and the rider tends to slip off the noseless saddle or tends to fall during fast riding and quick steering. As can be seen, at present, the saddle structure applied to the bicycle cannot avoid pressing and injuring the perineal region of a rider when the rider rides with a forward-leaning posture and also cannot avoid a likely fall during riding. To resolve the deficiencies that a saddle in the prior art cannot avoid pressing and injuring the perineal region of a rider and also cannot avoid a likely fall at steering during riding, a saddle structure and a bicycle in the following embodiments are provided.

### Embodiment 1

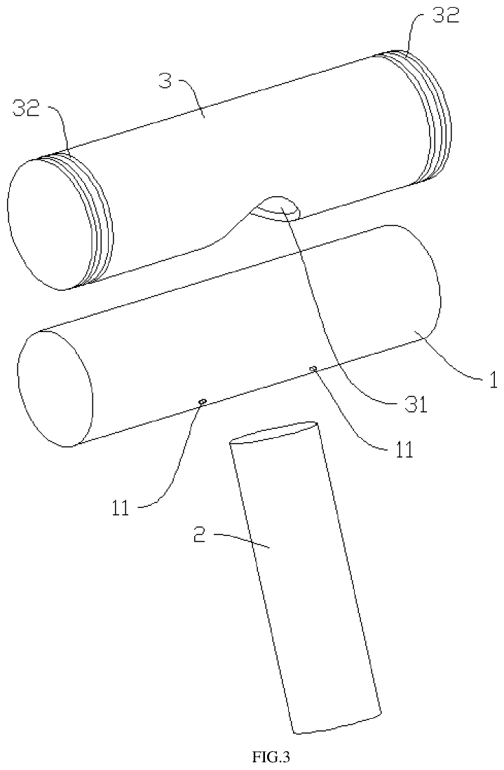

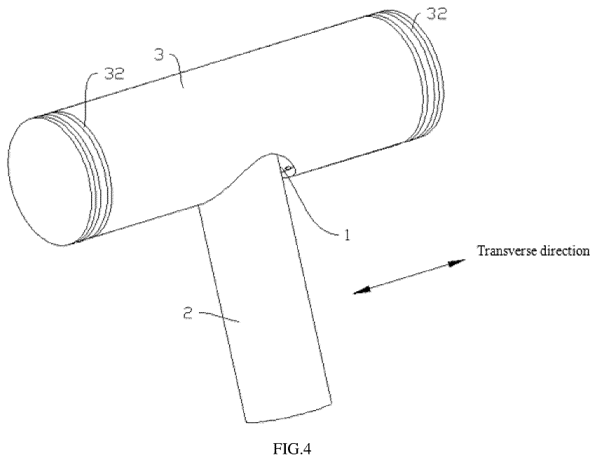

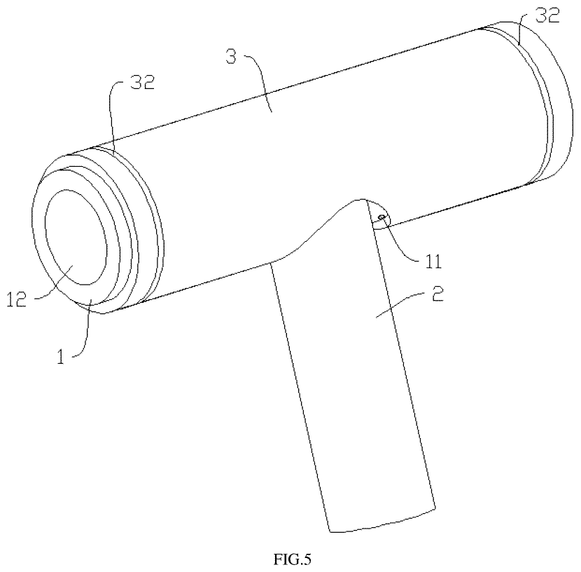

FIG. 3 and FIG. 4 show a saddle structure provided in this embodiment. The saddle structure is applied to a bicycle. The saddle structure includes a seat member 1. The seat member 1 is configured to be horizontally arranged at along a transverse direction a top of a seat tube 2 of the bicycle. A cross-section of the seat member 1 perpendicular to the transverse direction is a circle. It may be understood that the transverse direction in this embodiment is a transverse direction in FIG. 4.

In the saddle structure in this embodiment, the seat member 1 is arranged at the top of the seat tube 2 of the bicycle in the transverse direction, and the cross-section of the seat member 1 is a circle. When a rider rides the bicycle equipped with the saddle structure in this embodiment with a forward-leaning posture, a special arc-shaped support surface of the seat member 1 is configured to support the buttocks and the rear sides of the thighs of the rider, so that a support point of the seat member 1 for the body of the rider can smoothly change from the ischial tuberosity to the rear-side region of the thighs of the rider, and the support point of the seat member 1 for the body of the rider changes synchronously and consistently with a riding posture. In one aspect, the center of gravity of the human body of the rider and the center of gravity of the bicycle change harmoniously and consistently during movement, allowing the riding to cope with complex and varied road conditions more stably, thereby ensuring riding safety. In another aspect, muscles at different positions from the ischial tuberosity to the rear-side region of the thighs alternately bear pressing and rest to achieve comfort and health protection, and the perineal region of the rider is not pressed. When the rider rides the bicycle equipped with the saddle structure in this embodiment with a forward-leaning posture, the perineal region of the rider can be kept from being pressed and injured, and it can be ensured that the bicycle does not fall easily at steering during riding, thereby improving the safety factor during riding. For the saddle structure in this embodiment, the seat member 1 is connected to the seat tube 2 of the bicycle. When the rider steers the bicycle equipped with the saddle structure in this embodiment during riding, with the seat tube 2 as an axis, one side of the body of the rider presses an end on the same side of the seat member 1 through the support point to generate a steering force, so that the overall bicycle equipped with the saddle structure in this embodiment naturally steers, thereby overcoming the problem of inharmonious overall steering of a bicycle with a noseless saddle in the prior art, improving the safety factor of riding, and more effectively avoiding a likely fall when the rider steers the bicycle equipped with the saddle structure in this embodiment during riding.

It needs to be noted that an existing strip-shaped saddle or noseless saddle is essentially a fixed board and only simply supports the human body during movement, and a bicycle saddle remains in the level of a support point for the buttocks being fixed. A bicycle essentially keeps moving, and a rider on the bicycle also keeps moving. A supporting manner for a human body using the fixed support point for the buttocks of the existing strip-shaped saddle or noseless saddle limits to some extent the body freedom of the rider to adapt to changes in complex road conditions. The cross-section of the seat member 1 in the saddle structure in this embodiment is a circle. Due to a special arc-shaped support surface of the seat member 1, a support point of the seat member 1 for the body of the rider can smoothly change from the ischial tuberosity to the rear-side region of the thighs, so that synchronous and consistent changes can be kept according to adjustments of a riding posture, and the rider can keep balance with the overall center of gravity of the bicycle during riding, allowing the riding to cope with complex and varied road conditions more stably, thereby ensuring riding safety. In addition, muscles at different support point positions alternately bear pressing and rest for adjustment, thereby providing the effects of promoting blood circulation in legs and mitigating riding fatigue during riding.

When a rider rides the bicycle with a forward-leaning posture, air resistance is generated as the bicycle moves forward, and a backward reactive force is generated when the bicycle is pedaled forward. An existing bicycle saddle supports the buttocks of the body of a rider in the form of a planar shape. A force of friction between the buttocks and the saddle, a reactive force generated when the bicycle is pedaled forward, and an air resistance of moving forward form a balance force. This force does not have a stable fulcrum. The rider needs to consume energy to coordinate the overall body when moving forward. The human body is prone to fatigue after riding using an existing bicycle saddle for a long time. The saddle structure in this embodiment uses the seat member 1 horizontally mounted at a top part of the seat tube 2 of the bicycle in the transverse direction. During riding, a support point from the ischial tuberosity to the rear sides of the thighs of the human body naturally forms a force-bearing point for the reactive force of pedaling forward during riding and the air resistance of moving forward. A balanced reactive force is naturally formed with this force-bearing point, and the human body does not need to additionally work to generate a balanced force, to keep a rider from being prone to fatigue during riding on the bicycle equipped with the saddle structure in this embodiment.

When a rider pedals and rides the bicycle equipped with the saddle structure in this embodiment with the upper body leaning forward, a natural support point is formed between muscles from the ischial tuberosity to the rear sides of the thighs and the seat member 1 in the saddle structure in this embodiment. This support point naturally and correspondingly changes as the sitting posture changes. Because a vertical section of the seat member 1 in the saddle structure in this embodiment is an overall arc surface, corresponding change actions of the support point along with the riding posture are smooth and natural, and buttock movement and hunching for adjusting the riding posture for an existing planar-shaped bicycle saddle are avoided. In addition, discomfort that a noseless saddle presses rear-side muscles of the thighs is overcome, and smooth changes of a support point corresponding to a riding sitting posture allow a rider to straighten whole legs each time when the rider pushes the pedals of the bicycle, thereby reducing lateral forces that the knee joints bear, and achieving the comfort of pedaling with a standing posture. In addition, the pedals can be better pushed to apply riding power, and discomfort in knee bending can be reduced. In addition, the support point is used as a fulcrum, and body portions in front of and behind the support point and the support point form a seesaw structure. When the left foot pedals downward to apply riding power, the waist and hip portions behind a left-side support point slightly move upward. Correspondingly, the right foot moves upward, and the waist and hip portions behind a right-side support point slightly move downward. This cycle is repeated, so that the gravity of the human body can be better converted into riding power, which especially facilitates riding uphill.

In a process that a rider steers the bicycle equipped with the saddle structure in this embodiment, when the rider pushes the pedal downward, the buttocks behind the support point on the same side move upward. Muscles near the support point rotate downward around the support point. The left foot and the right foot pedal alternately, and muscles near riding support points on the left and right rotate alternately around the support points. For example, the left foot pedals downward, and muscles near the left-side support point are rotated and pressed. At the same time, the right foot moves upward, and muscles near the right-side support point are released. During riding and forward movement, muscles near the support point on the rear sides of the left and right thighs are alternately rotated, pressed, and released, to achieve the effects of promoting blood circulation in legs and mitigating riding fatigue.

When the rider steers the bicycle equipped with the saddle structure in this embodiment during riding, with the seat tube 2 as an axis, one side of the body of the rider presses an end on the same side of the seat member 1 through the support point to generate a steering force. For example, during steering to the left, while the handlebar is controlled with hands to steer left, the left side of the body presses a left end of the seat member 1 backward through the support point to generate a steering force. In this way, the overall bicycle steers naturally to the left side, thereby overcoming the problem of inharmonious overall steering of an existing bicycle with a noseless saddle. During fast riding, such timely harmonious overall steering is particularly important, thereby improving the safety factor of riding, and avoiding the unsafe feeling that during riding of a bicycle with a noseless saddle, when the waist and hip are twisted to steer, the buttocks may slip off the saddle.

In a process of riding the bicycle equipped with the saddle structure in this embodiment on a bumpy road, when the human body of a rider and the seat member 1 press and contact through arc-shaped surfaces at front and rear positions, upward impact forces from the shake and vibration during riding are dispersed and cushioned by an arc-shaped surface of the seat member 1 at the support point and an arc-shaped surface of concave muscle of the rider formed through contact and pressing. An existing bicycle saddle supports the buttocks of the body of a rider in the form of a planar shape, and upward impact forces from the vibration during riding directly act on the buttocks or the perineal region of the rider, and cause great pain to the rider in severe cases. When the human body and the saddle structure in this embodiment press and contact through positive support by arc-shaped surfaces at an upper position and a lower position, a bow shape formed by the upper limbs and lower limbs in the forward-leaning riding posture has an instinctive human-body elastic deformation, so that the human body has a slight sliding bouncing at the position of the support point, thereby cushioning upward impact forces from the vibration during riding. Therefore, the bicycle equipped with the saddle structure in this embodiment provides a rider with safer and more comfortable riding experience. In addition, a natural shock absorption effect is provided through the combination of the characteristic of the special arc-shaped surface of the seat member 1 of the saddle structure in this embodiment and the forward-leaning riding posture of a human body, and the structure is simpler.

The saddle structure in this embodiment may be applied to a road bicycle, a mountain bicycle, an off-road bicycle, a fitness bicycle, and the like.

When the saddle structure in this embodiment is applied to a road bicycle with a curved handlebar, the flexibility of position changes of a support point of the seat member 1 of the saddle structure in this embodiment surpasses to some extent the effect of changing a handlebar position on the curved handlebar of the road bicycle to adjust a riding posture. To change the handlebar position on the curved handlebar, a rider needs to alternate actions of two hands, and the overall cooperation of the body is required. This poses more uncertain unsafe factors during high-speed riding. For example, to achieve an effect of changing a middle handlebar position during riding into a riding posture with hands gripping a lower handlebar position, during riding on a road bicycle equipped with the saddle structure in this embodiment, it is only necessary to slide backward like slightly rotating backward along the arc-shaped surface of the support point of the seat member 1 to make a riding support point slightly move backward, make the waist and abdomen move backward along, and at the same time make the upper body lean forward. This is more natural and smoother compared with a handlebar position switching action of a road bicycle, the safety is improved, the force load on the waist and abdomen and arms is reduced, and better safety and comfort are provided.

Specifically, a projection of a geometric center of the seat member 1 in a length direction of the seat tube 2 overlaps a geometric center of the seat tube 2 of the bicycle.

Optionally, the seat member 1 is arranged to have a hollow portion. With such an arrangement, the weight of the seat member 1 can be reduced while the structural strength of the seat member 1 is met, so that the weight of the saddle structure in this embodiment can be reduced, thereby reducing the weight of a bicycle equipped with the saddle structure in this embodiment to facilitate carrying.

As shown in FIG. 3, optionally, a flexible cushion 3 is disposed on a peripheral surface of the seat member 1. The flexible cushion 3 improves the feel of the buttocks of a rider touching the saddle structure in this embodiment, thereby improving the comfort and experience of a rider riding a bicycle equipped with the saddle structure in this embodiment.

As shown in FIG. 3, optionally, the flexible cushion 3 is provided with an avoidance groove 31 at a position corresponding to a bottom part of the seat member 1, and the bottom part of the seat member 1 is formed with a first through-hole 11 penetrating in a vertical direction corresponding to the position of the avoidance groove 31; and the first through-hole 11 is in communication with an inner cavity of the seat member 1. In consideration of that the temperature of the seat member 1 may rise in a process of a rider riding sitting on the saddle structure in this embodiment, the first through-hole 11 is added to communicate the inner cavity of the seat member 1 with external air to perform convective heat transfer, thereby achieving the effect of temperature reduction. It may be understood that during specific application, a quantity of the first through-holes 11 in this embodiment is appropriately selected according to an actual requirement. For example, in different embodiments, one, two, three, ten, fifteen, twenty, or another quantity of first through-holes 11 may be set.

Optionally, the flexible cushion 3 is arranged to be a skin layer. The skin layer has good wear resistance, to avoid wear damage after a period of time. In addition, the skin layer has good waterproof and heat insulation performance, thereby improving the experience of a rider.

Optionally, a mounting cavity is defined between an inner side wall of the flexible cushion 3 and the peripheral surface of the seat member 1, and a flexible filler is disposed in the mounting cavity. The flexible filler is added between the flexible cushion 3 and the seat member 1, so that better shock absorption can be achieved, thereby further improving the experience of a rider. Specifically, the material of the flexible filler may be latex, polyester, or another foamed material.

As shown in FIG. 4, optionally, an outer wall of the flexible cushion 3 is provided with an anti-slip annular band 32 at each of two ends thereof in the transverse direction, and the anti-slip annular band 32 is arranged along a circumferential direction of the seat member 1. The anti-slip annular band 32 further increases a force of friction with the human body of a rider in the transverse direction, so that the buttocks of a rider can be more effectively kept from slipping off the saddle structure in this embodiment.

### Embodiment 2

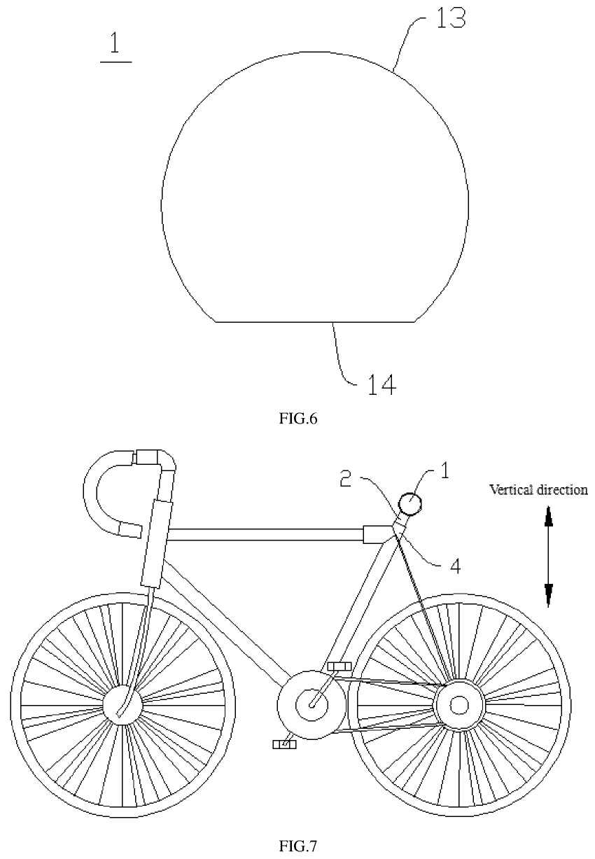

FIG. 5 shows a saddle structure provided in this embodiment. A difference between this embodiment and Embodiment 1 lies in that a specific structure of the seat member 1 is different. In this embodiment, at least one end of the seat member 1 in the transverse direction is formed with a second through-hole 12 penetrating in the transverse direction, and the second through-hole 12 is in communication with an inner cavity of the seat member 1. The second through-hole 12 increases an area of convective heat transfer of communication between the inner cavity of the seat member 1 and external air, thereby achieving a better heat transfer effect. However, because rainwater tends to enter the inner cavity of the seat member 1 through the second through-hole 12, the first through-hole 11 can further be used as a drainage hole to drain water that enters the inner cavity of the seat member 1.

To achieve a better heat transfer effect, specifically, each of two ends of the seat member 1 in the transverse direction is formed with the second through-hole 12 penetrating in the transverse direction.

### Embodiment 3

FIG. 6 shows a saddle structure in this embodiment. A difference between this embodiment and Embodiment 1 lies in that a specific structure of the seat member 1 is different. In this embodiment, a cross-section of the seat member 1 perpendicular to the transverse direction includes an arc portion 13 extending for at least three fourths of the full circle, and a horizontal portion 14 is disposed at a bottom part of the cross-section of the seat member 1 perpendicular to the transverse direction. The horizontal portion 14 and the arc portion 13 define the cross-section of the seat member 1. When a rider rides the bicycle equipped with the saddle structure in this embodiment with a forward-leaning posture, the perineal region of the rider can be kept from being pressed and injured, blood circulation in legs can be promoted, riding fatigue can be mitigated, and the safety factor of steering during riding can be improved. Based on this, through the horizontal portion 14, it is convenient to mount the seat member 1 at a top of the seat tube 2 of the bicycle, the connection is more secure, and the connection achieves better fastening.

It may be understood that the structure of the seat member 1 in Embodiment 3 may be formed by cutting a part of a lower end of the cylindrical seat member 1 Embodiment 1 in the transverse direction.

### Embodiment 4

FIG. 7 shows a bicycle provided in this embodiment, including a seat tube 2 and a saddle structure disposed at a top of the seat tube 2, where the saddle structure is configured as the saddle structure in Embodiment 1 or Embodiment 2 or Embodiment 3.

In the saddle structure in the bicycle in this embodiment, the seat member 1 is arranged at the top of the seat tube 2 in the transverse direction, and the cross-section of the seat member 1 includes the arc portion that is disposed at the top part of the cross-section and extends for at least three fourths of the full circle. When a rider rides the bicycle in this embodiment with a forward-leaning posture, a special arc-shaped support surface of the seat member 1 is configured to support the buttocks and the rear sides of the thighs of the rider, so that a support point of the seat member 1 for the body of the rider can smoothly change from the ischial tuberosity to the rear-side region of the thighs of the rider, and the support point of the seat member 1 for the body of the rider change synchronously and consistently with a riding posture. In one aspect, the center of gravity of the human body of the rider and the center of gravity of the bicycle change harmoniously and consistently during movement, allowing the riding to cope with complex and varied road conditions more stably, thereby ensuring riding safety. In another aspect, muscles at different positions from the ischial tuberosity to the rear-side region of the thighs alternately bear pressing and rest to achieve comfort and health protection, and the perineal region of the rider is not pressed. When a rider rides the bicycle in this embodiment with a forward-leaning posture, the perineal region of the rider can be kept from being pressed and injured, and it can be ensured that the bicycle does not fall easily at steering during riding, thereby improving the safety factor during riding. For the saddle structure in the bicycle in this embodiment, the seat member 1 is connected to the seat tube 2. When the rider steers the bicycle in this embodiment during riding, with the seat tube 2 as an axis, one side of the body of the rider presses an end on the same side of the seat member 1 through the support point to generate a steering force, so that the overall bicycle in this embodiment naturally steers, thereby overcoming the problem of inharmonious overall steering of a bicycle equipped with a noseless saddle in the prior art, improving the safety factor of riding, and more effectively avoiding a likely fall when the rider steers the bicycle in this embodiment during riding.

Specifically, the bicycle further includes a vertical tube 4, and the seat tube 2 is disposed at a top of the vertical tube 4.

As shown in FIG. 4 and FIG. 6, optionally, the seat tube 2 is disposed obliquely, and an angle between an arrangement direction of the seat tube 2 and a vertical direction is an acute angle. In this way, when a rider rides the bicycle in this embodiment with a forward-leaning posture, a special arc-shaped support surface of the seat member 1 better supports the body of the rider, thereby further improving the experience of the rider. The vertical direction in this embodiment is a vertical direction in FIG. 6.

Obviously, the foregoing embodiments are merely examples for clear description, rather than a limitation to implementations. For a person of ordinary skill in the art, other changes or variations in different forms may also be made based on the foregoing description. All implementations cannot and do not need to be exhaustively listed herein. Obvious changes or variations that are derived there from still fall within the protection scope of present application.

1. A saddle structure, applied to a bicycle, wherein the saddle structure comprises:
a seat member, configured to be horizontally arranged along a transverse direction at a top of a seat tube of the bicycle, wherein a cross-section of the seat member perpendicular to the transverse direction comprises an arc portion extending for at least three fourths of a full circle, and the arc portion is disposed at a top part of the cross-section.

2. The saddle structure according to claim 1, wherein the cross-section of the seat member perpendicular to the transverse direction is arranged to be circular.

3. The saddle structure according to claim 1, wherein the seat member is arranged to have a hollow portion.

4. The saddle structure according to claim 3, wherein a flexible cushion is disposed on a peripheral surface of the seat member.

5. The saddle structure according to claim 4, wherein the flexible cushion is provided with an avoidance groove at a position corresponding to a bottom part of the seat member, and the bottom part of the seat member is formed with a first through-hole penetrating in a vertical direction; and the first through-hole is in communication with an inner cavity of the seat member.

6. The saddle structure according to claim 4, wherein at least one end of the seat member in the transverse direction is formed with a second through-hole penetrating in the transverse direction, and the second through-hole is in communication with an inner cavity of the seat member.

7. The saddle structure according to claim 6, wherein each of two ends of the seat member in the transverse direction is formed with the second through-hole penetrating in the transverse direction.

8. The saddle structure according to claim 4, wherein the flexible cushion is arranged to be a skin layer;
and/or, a mounting cavity is defined between an inner side wall of the flexible cushion and the peripheral surface of the seat member, and a flexible filler is disposed in the mounting cavity.

9. The saddle structure according to claim 4, wherein an outer wall of the flexible cushion is provided with an anti-slip annular band at each of two ends thereof in the transverse direction, and the anti-slip annular band is arranged along a circumferential direction of the seat member.

10. A bicycle, comprising a seat tube and a saddle structure disposed at a top of the seat tube, wherein the saddle structure is configured as the saddle structure according to claim 1.
